(19) United States
(12) Patent Application Publication
(10) Pub. No.: US 2025/0373400 A1
(43) Pub. Date: Dec. 4, 2025

(54) OPTIMAL RADIUS AND SUBCARRIER MAPPING FOR BMOCZ

(71) Applicant: UNIVERSITY OF SOUTH CAROLINA, COLUMBIA, SC (US)

(72) Inventors: PARKER HUGGINS, GREENVILLE, SC (US); ALPHAN SAHIN, COLUMBIA, SC (US)

(21) Appl. No.: 19/200,848

(22) Filed: May 7, 2025

Related U.S. Application Data
(60) Provisional application No. 63/655,654, filed on Jun. 4, 2024.
(60) Provisional application No. 63/737,940, filed on Dec. 23, 2024.

(51) Int. Cl. H04L 5/00; H04L 25/49

(52) U.S. Cl. CPC H04L 5/0098; H04L 5/0007; H04L 25/49

(57) ABSTRACT

The disclosure deals with system and method for discerning the radius maximizing reliability for binary modulation on conjugate-reciprocal zeros (BMOCZ) implemented with both a maximum likelihood (ML) and direct zero-testing (DiZeT) decoder. The optimal radius for BMOCZ is disclosed to be a function of the employed decoder. The radius maximizing the minimum distance between polynomial zeros does not maximize the minimum distance of the final code. While maximizing zero separation offers an almost optimal solution for the DiZeT decoder, the ML decoder outperforms the DiZeT decoder in both additive white Gaussian noise (AWGN) and fading channels when the radius is chosen to maximize codeword separation. Different sequence-to-subcarrier mappings for BMOCZ-based orthogonal frequency division multiplexing (OFDM) are analyzed to highlight a flexible time-frequency mapping approach that avoids distortion introduced by a frequency-selective channel at the expense of higher peak-to-average power ratio (PAPR).

### PRIORITY CLAIMS

The present application claims the benefit of priority of U.S. Provisional Patent Application No. 63/655,654, filed Jun. 4, 2024, and the benefit of priority of U.S. Provisional Patent Application No. 63/737,940, filed Dec. 23, 2024, both of which are titled Optimal Radius and Subcarrier Mapping for BMOCZ, and both of which are fully incorporated herein by reference for all purposes.

### BACKGROUND OF THE PRESENTLY DISCLOSED SUBJECT MATTER

Binary modulation on conjugate-reciprocal zeros (BMOCZ) is a modulation scheme allowing for digital information to be impressed on electromagnetic radiation. BMOCZ works by encoding message bits into the zeros of a polynomial and letting the coefficients of this polynomial modulate a carrier. A crucial parameter in the design of BMOCZ is a radius parameter determining the spacing between conjugate-reciprocal zero pairs. In this present disclosure, we identify the radius that maximizes the reliability of BMOCZ. Further, we introduce subcarrier mapping strategies that allow for the integration of BMOCZ with orthogonal frequency division multiplexing (OFDM), a multi-carrier modulation scheme that is commonplace in modern wireless networks.

### I. INTRODUCTION

Unlike the previous generations of cellular systems concerned with improving data rate for human users, Fifth Generation (5G) New Radio (NR) has called for the development of various novel use cases, including machine-type [1] and ultra-reliable low-latency communications [2]. Along with connecting users, sensors, and devices on a never-before-seen scale, these systems require flexible communication technologies that are adaptable to different environments. Moreover, the sparsity of these systems motivates communication via the frequent transmission of sporadic short-packets [3], a type of communication whose architecture fundamentally differs from those used today [4].

Looking towards sixth generation wireless networks, noncoherent communication strategies have gained traction for their ability to scale with the anticipated stark increase in wireless connectivity [5]. Furthermore, the low complexity and low power consumption of non-coherent based communication hardware lends itself to application in the Internet of Things (IoT) [6], where the billions of devices connected worldwide will pose challenges to current communication infrastructure. A non-coherent communication system is one in which the receiver has no explicit knowledge of channel state information (CSI). In this case, equalization techniques that are commonplace in modern wireless communication systems cannot be used for symbol detection; rather, the receiver must perform “blind” demodulation of the received signal. Consequently, the design of non-coherent communication systems that are both reliable and practical proves challenging [7].

A recently proposed non-coherent communication scheme for short packets is modulation on conjugate-reciprocal zeros (MOCZ). Using MOCZ, information bits are encoded into the zeros of the baseband signal's z-transform. The baseband signal thus takes the form of a polynomial in the z-domain, and the transmitted sequence comprises the coefficients of this polynomial [8]. A particular advantage of MOCZ is that the polynomial zeros are unaffected by the channel impulse response (CIR), since the convolution of the polynomial coefficients with the CIR corresponds to polynomial multiplication in the z-domain; this operation may introduce extraneous zeros to the received sequence but not alter those already transmitted [9]. Both the theoretical and practical aspects of MOCZ are studied extensively in [9], [10].

In particular, a variant of MOCZ is introduced whereby each information bit is encoded into the zero of a conjugate-reciprocal zero pair. The technique is called binary modulation on conjugate-reciprocal zeros (BMOCZ), and it yields polynomial coefficients that form Huffman sequences [11]. Furthermore, various improvements and applications of MOCZ have been considered in the literature. For example, the authors in [12]propose spectrally-efficient BMOCZ using faster-than-Nyquist signaling. In [13], codebooks are introduced for MOCZ that reduce peak-to-average power ratio (PAPR). In [14] and [15], the authors investigate diversity techniques and multi-user access for MOCZ, respectively.

The inventors of binary modulation on conjugate-reciprocal zeros (BMOCZ) have a startup that continues the development of BMOCZ for implementation in future wireless networks (https://www.moxz.tech/index.html #hero). Moreover, reliable and efficient non-coherent communication schemes are sure to be discussed in 3GPP and IEEE 802.11 meetings on 6G and WiFi, respectively.

Within the last decade, non-coherent communication schemes have gained traction for their ability to scale the growing demands for network capacity. Binary modulation on conjugate-reciprocal zeros (BMOCZ) is a novel non-coherent communication scheme for short-packets that has many advantages over existing non-coherent communication strategies. Therefore, it is of paramount importance to optimize both the performance and flexibility of BMOCZ. For this reason, our present disclosure addresses the optimal design radius for BMOCZ, as well as techniques for integration with orthogonal frequency division multiplexing (OFDM). The present disclosure furthers both the reliability and practicality of the already proposed BMOCZ.

### SUMMARY OF THE PRESENTLY DISCLOSED SUBJECT MATTER

In this present disclosure, we identify the radius maximizing reliability for binary modulation on conjugate-reciprocal zeros (BMOCZ) implemented with both a maximum likelihood (ML) and direct zero-testing (DiZeT) decoder. We first demonstrate that the radius maximizing the distance between polynomial zeros is different from that maximizing the minimum distance of the final code. Using simulations, we then disclose that the optimal decoder for BMOCZ in both additive white Gaussian noise (AWGN) and fading channels is the ML decoder when the radius is chosen to maximize codeword separation. Finally, we introduce three sequence-to-subcarrier mappings for BMOCZ-based orthogonal frequency division multiplexing (OFDM) and highlight a presently disclosed time-mapping approach that can accommodate large polynomial sequences at the expense of increased peak-to-average power ratio (PAPR).

In the general area of electrical-based technology, the presently disclosed subject matter relates to one or more sub-areas of binary modulation on conjugate-reciprocal zeros (BMOCZ), non-coherent communication, orthogonal frequency division multiplexing (OFDM), Huffman polynomials (sequences), subcarrier mappings, waveforms, and zeros of polynomials.

Because non-coherent communication schemes and BMOCZ specifically are of promise for implementation in the Internet-of-Things and machine-type communication systems, the anticipated market size is large. The technology has potential applications in, sensor networks, radar, autonomous vehicles, robotics, and more.

The innovation is notable for two primary reasons: (1) it maximizes the reliability of binary modulation on conjugate-reciprocal zeros (BMOCZ), a novel but promising non-coherent communication scheme; and (2) it presently discloses methods for the integration of BMOCZ with a well-established technology, i.e., orthogonal frequency division multiplexing (OFDM). The first point affects mainly users, as design with the optimal radius helps ensure both reliable and secure communication. The second point affects industries and governing bodies for communication in particular (e.g., IEEE, 3GPP, ETSI, etc.), for the integration of novel communication schemes with existing technologies will ease the transition into sixth generation wireless networks, reducing personnel, field, and production costs.

In various exemplary embodiments disclosed herewith, methods and systems for binary data transmission are described.

One exemplary such method relates to a binary data transmission method, comprising using a non-coherent communication scheme for transmitting a discrete-time baseband signal, comprising a binary modulation on conjugate-reciprocal zeros (BMOCZ) modulation scheme, using a polynomial scheme for encoding and decoding; wherein BMOCZ has a radius parameter R determining the spacing between conjugate-reciprocal zero pairs, the radius parameter R is selected to be greater than 1, and R is selected to maximize zero or polynomial separation, depending on the implemented decoder at the receiver.

It is to be understood that the presently disclosed methodology subject matter equally relates to associated and/or corresponding systems and/or devices. For example, other example aspects of the present disclosure are directed to systems, apparatus, tangible, non-transitory computer-readable media, user interfaces, memory devices, and electronic devices for binary data transmission. To implement methodology and technology herewith, one or more processors may be provided, programmed to perform the steps and functions as called for by the presently disclosed subject matter, as will be understood by those of ordinary skill in the art.

Another exemplary embodiment of presently disclosed subject matter relates to a system for addressing a binary data transmission system, comprising an input source for providing information bits; one or more processors; and one or more non-transitory computer-readable media that store instructions that, when executed by the one or more processors, cause the one or more processors to perform operations, the operations comprising generating a baseband signal; and using a non-coherent communication scheme for transmitting the baseband signal, comprising a binary modulation on conjugate-reciprocal zeros (BMOCZ) modulation scheme, using a polynomial scheme for encoding and decoding; wherein BMOCZ has a radius parameter R determining the spacing between conjugate-reciprocal zero pairs, the radius parameter R is selected to be greater than 1, and R is selected to maximize zero or polynomial separation, depending on the implemented decoder at the receiver.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1(a) graphically illustrates minimum codeword separation versus R values, for various K values, in accordance with presently disclosed subject matter;

FIG. 1(b) graphically illustrates the radius maximizing codeword separation and maximizing zero separation for various K values, in accordance with presently disclosed subject matter;

FIG. 2(a) graphically illustrates presently disclosed time-mapping principal sequence-to-subcarrier mappings for BMOCZ-based orthogonal frequency division multiplexing (OFDM), in accordance with presently disclosed subject matter;

FIG. 2(b) graphically illustrates presently disclosed frequency-mapping principal sequence-to-subcarrier mappings for BMOCZ-based orthogonal frequency division multiplexing (OFDM), in accordance with presently disclosed subject matter;

FIG. 2(c) graphically illustrates presently disclosed time-frequency mapping principal sequence-to-subcarrier mappings for BMOCZ-based orthogonal frequency division multiplexing (OFDM), in accordance with presently disclosed subject matter;

FIG. 3 graphically illustrates a block diagram representing exemplary processing of the mth OFDM symbol for a BMOCZ-based OFDM system implemented with presently disclosed frequency-mapping approach (m=p) in accordance with presently disclosed subject matter;

FIG. 4(a) graphically illustrates the bit error rate (BER) performance curves simulated in an AWGN channel for BMOCZ with K∈{4, 7, 10}, implemented with both ML and DiZeT decoders at optimal radius, in accordance with presently disclosed subject matter;

FIG. 4(b) graphically illustrates the block error rate (BLER) performance curves simulated in an AWGN channel for BMOCZ with K∈{4, 7, 10}, implemented with both ML and DiZeT decoders at optimal radius, in accordance with presently disclosed subject matter;

FIG. 5(a) graphically illustrates the bit error rate (BER) performance curves of the ML and DiZeT decoders in a fading channel with L=1, implemented with both ML and DiZeT decoders at optimal radius, in accordance with presently disclosed subject matter;

FIG. 5(b) graphically illustrates the block error rate (BLER) performance curves of the ML and DiZeT decoders in a fading channel with L=1, implemented with both ML and DiZeT decoders at optimal radius, in accordance with presently disclosed subject matter;

FIG. 6(a) graphically illustrates the complementary cumulative distribution function (CCDF) of peak-to-average power ratio (PAPR) for BMOCZ-based OFDM waveforms employing different sequence-to-subcarrier mappings, including computed for K∈{7, 9} and the radius Rfrom Equation (9) herein, in accordance with presently disclosed subject matter;

FIG. 6(b) graphically illustrates another example of the complementary cumulative distribution function (CCDF) of peak-to-average power ratio (PAPR) for BMOCZ-based OFDM waveforms employing different sequence-to-subcarrier mappings, including computed for K∈{7, 9} and the radius R from Equation (11) herein, in accordance with presently disclosed subject matter;

FIG. 7(a) graphically illustrates the bit error rate (BER) performance curves of the OFDM subcarrier mappings in a fading channel for L=K=9 and p=0.2, in accordance with presently disclosed subject matter; and

FIG. 7(b) graphically illustrates the block error rate (BLER) performance curves of the OFDM subcarrier mappings in a fading channel for L=K=9 and p=0.2, in accordance with presently disclosed subject matter.

Repeat use of reference characters in the present specification and drawings is intended to represent the same or analogous features, elements, or steps of the presently disclosed subject matter.

### DETAILED DESCRIPTION OF THE PRESENTLY DISCLOSED SUBIECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to methodology and system subject matter which maximizes the reliability of binary modulation on conjugate-reciprocal zeros (BMOCZ), a non-coherent communication scheme. The present disclosure is further directed to the integration of BMOCZ with a well-established technology, namely, orthogonal frequency division multiplexing (OFDM).

### II. PRELIMINARIES

A crucial parameter in the design of BMOCZ is a radius that gives the placement of conjugate-reciprocal zero pairs. The choice of this radius determines the separation between both zero-vectors and codewords, i.e., factors influencing the performance of the communication scheme. For this reason, the radius maximizing zero separation for BMOCZ, shown in Eq. [9], was previously identified and introduced in conjunction with a direct zero-testing (DiZeT) decoder to retrieve transmitted zeros from the received polynomial sequence. To our knowledge, however, the optimal radius for BMOCZ in general is not addressed.

Therefore, in this preliminary work, we refer to the optimal radius for BMOCZ implemented using both a maximum likelihood (ML) and DiZeT decoder. We disclose that the ML decoder outperforms the DiZeT decoder in both additive white Gaussian noise (AWGN) and fading channels for appropriate choices of the radius parameter. Moreover, the merits of different subcarrier mapping strategies for BMOCZ-based orthogonal frequency division multiplexing (OFDM) are discussed. Simulations of the presently disclosed OFDM waveforms in a fading channel demonstrate that a time-mapping approach achieves the best block error rate (BLER) performance at the expense of increased PAPR.

Notation: The set of complex numbers is denoted [symbol] , and the complex-conjugate of a complex number z*=a+jb is expressed as z*=a−jb. We denote the Euclidean norm of a vector v∈ [symbol] ^{N×1} as ∥v∥₂=\sqrt{v^{H}v}. The probability of an event A given event B is denoted Pr(A|B). The circularly symmetric complex normal distribution with zero-mean and variance σ² is expressed as CN(0, σ²). The expected value of a random variable X is denoted [symbol] [X].

This section reviews BMOCZ and describes the two decoders considered in this work (i.e., maximum likelihood (ML) and direct zero-testing (DiZeT)). To begin, consider a binary message m=(m₁,m₂, . . . ,m_{K}). Using BMOCZ, the K message bits are modulated onto K distinct zeros according to

$${α}_{k} = \{ \begin{matrix}R {e}^{j 2 π ( k - 1 ) / K} , & {m}_{k} = 1 \\ \frac{1}{R} {e}^{j 2 π ( k - 1 ) / K} , & {m}_{k} = 0\end{matrix} , \qquad ( 1 )$$

where k=1, 2, . . . , K and R>1 is a radius determining the distance between conjugate-reciprocal zero pairs. By the fundamental theorem of algebra, the K zeros define a polynomial of degree I, namely,

$$X ( z ) = {x}_{K} {\prod }_{k = 0}^{K - 1} ( z - {α}_{k} ) , \qquad ( 2 )$$

where z∈ [symbol] and x_{K}≠0 is a scalar multiple that does not affect the zero locations of X(z). In discrete-time, the baseband sequence to transmit comprises the polynomial coefficients of X(z), i.e., x=(x₀, x₁, . . . , x_{K})^{T}.

For the duration of transmission, it is assumed that the channel is linear time-invariant (LTI) with an L-tap impulse response h=(h₀, h₁, . . . , h_{L-1})^{T}. Using the convolution theorem, the received sequence y=(y₀, y₁, . . . , y_{K+L-1})^{T} can be expressed in the z-domain as

$$Y ( z ) = X ( z ) H ( z ) + W ( z ) , \qquad ( 3 )$$

where H(z) and W(z) represent the unilateral z-transform of h and a noise sequence w=(w₀, w₁, . . . , w_{K+L-1})^{T}, respectively. Note that H(z) and W(z) are both polynomials in the complex variable z and can thus be written in the form

$$H ( z ) = {h}_{L - 1} {{\prod }_{l - 0}}^{L - 2} ( z - {β}_{l} ) \qquad ( 4 )$$

$$and$$

$$W ( z ) = {w}_{N - 1} {{\prod }^{N - 2}}_{n = 0} ( z - {γ}_{n} ) , \qquad ( 5 )$$

where N=K+L. Therefore, the polynomial in (3) has a total of N−1 zeros, K of which are information-bearing.

The authors in [9]propose several methods for demodulating and decoding the received polynomial sequence. In particular, introduced are a ML and DiZeT decoder. The ML decoder estimates the transmitted zeros by searching over all possible zero-vectors α∈ [symbol] ^{K}, where [symbol] ^{K} is the BMOCZ zero-codebook for a given K The codebook is generated by taking the Cartesian product of all conjugate-reciprocal zero pairs [symbol] ₖ={αₖ, 1/αₖ*}, i.e., [symbol] ^{K}= [symbol] ₁× [symbol] ₂× . . . × [symbol] _{K}. Using the ML decoder, assuming a uniform power-delay profile (PDP) [9], an estimate of the transmitted zeros is obtained directly as

$$\hat{α} = {‖ {( {V}_{α}^{H} {V}_{α} )}^{- \frac{1}{2}} {V}_{α}^{H} y ‖}_{2}^{2} , \qquad ( 6 )$$

where

$${V}_{α}^{H}$$

is the K×N Vandermonde matrix

$${V}_{α}^{H} = ( \begin{matrix}1 & {α}_{1} & {α}_{1}^{2} & … & {α}_{1}^{N - 1} \\ 1 & {α}_{2} & {α}_{2}^{2} & … & {α}_{2}^{N - 1} \\ ⋮ & ⋮ & ⋮ & ⋱ & ⋮ \\ 1 & {α}_{K} & {α}_{2}^{K} & … & {α}_{K}^{N - 1}\end{matrix} ) . \qquad ( 7 )$$

Instead of searching across all α∈ [symbol] ^{K},the DiZeT decoder simply evaluates the received polynomial in (3) at the zeros in [symbol] ₖ. The kth transmitted zero is then estimated as

$${\hat{α}}_{k} = {R}^{- \frac{N - 1}{2}} \vert Y ( {α}_{k} ) \vert , \qquad ( 8 )$$

where the weighting factor R^{-(N-1)1/2} is introduced to scale the output of |Y (αk)| to balance the exponential nature of the polynomial coefficients [9].

### III. OPTIMAL RADIUS

The form of (1) raises a natural question: for a given K, what is the radius R that maximizes the reliability of BMOCZ? The accepted answer in current literature is the radius which maximizes the separation between zeros [9], [10], [12], i.e.,

$${R}_{D Z} ( K ) = \sqrt{1 + sin ( π / K )} . \qquad ( 9 )$$

This result is intuitive for BMOCZ employing the DiZeT decoder, for the received polynomial sequence is directly evaluated at the possible zero locations. The ML decoder, however, does not involve the explicit evaluation of (3) at any zeros. Moreover, the ML decoder is derived from the general maximum likelihood sequence estimator (MLSE) [16] given by

$$\hat{x} = Pr ( y \vert x ) , \qquad ( 10 )$$

where [symbol] ^{K} is the BMOCZ polynomial-codebook for a given K[9]. Since the optimization is performed over polynomial sequences and not zeros, it is best to choose the radius that maximizes the separation between codewords:

$${R}_{ML} ( K ) = {arg max}_{R > 1} ( ‖ {x}_{i} - {x}_{j} {‖}_{2}^{2} ) , i \neq j . \qquad ( 11 )$$

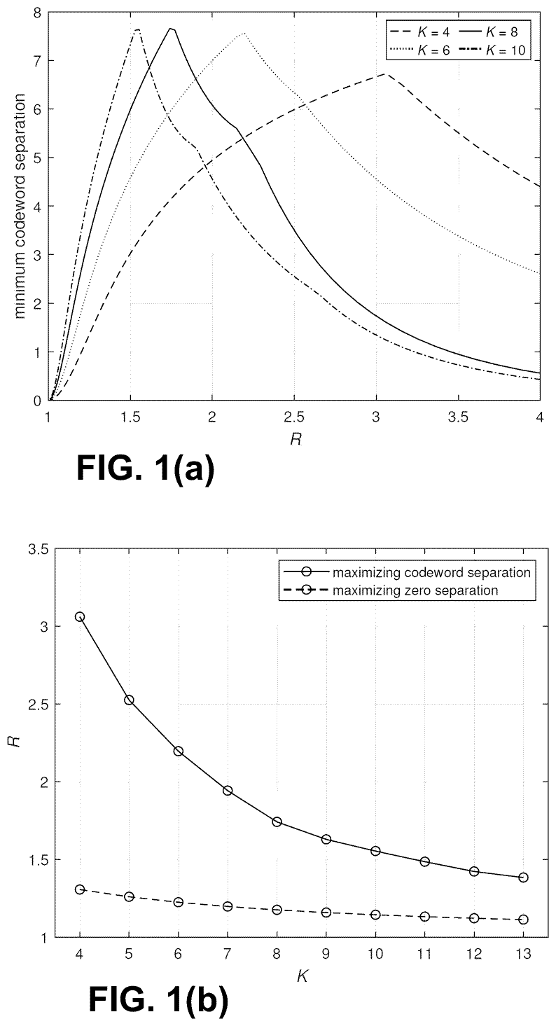

To compare the radii given in (9) and (11), we generate BMOCZ zero- and polynomial-codebooks for various K FIG. 1(a) graphically illustrates minimum codeword separation versus R values, for various K values, in accordance with presently disclosed subject matter. In particular, FIG. 1(a) displays the minimum observed codeword separation for K∈{4, 6, 8, 10} and R∈{1, 4}. FIG. 1(b) graphically illustrates the radius maximizing codeword separation and maximizing zero separation for various K values, in accordance with presently disclosed subject matter. In particular, FIG. 1(b) shows the corresponding radius maximizing zero and codeword separation for K∈{4, 5, . . . , 13}, i.e., the radius computed in accordance with (9) and (11), respectively. For all K, notice that the radius maximizing codeword separation is greater than that maximizing zero separation. It follows that the optimal radius for BMOCZ is a function of the utilized decoder.

### A. OFDM Subcarrier Mappings

This section outlines how we construct BMOCZ-based OFDM waveforms to limit the number of zeros introduced by the channel [15]. We begin by considering a binary message of length B K Next, Ppolynomials are generated by mapping every K bits of the message to sequences via BMOCZ. Let xpkdenote the kth coefficient of the pth polynomial for p∈{0, 1, . . . , P−1} and k∈{0, 1, . . . , K}. In principle, there exists three distinct sequence-to-subcarrier mappings: time-mapping, frequency-mapping, and time-frequency mapping. In what follows, we discuss the merits of each approach. With time-mapping, the polynomial sequences are mapped to [symbol] =P subcarriers such that the [symbol] th subcarrier constitutes K+1 OFDM symbols. Specifically, the mth OFDM symbol can be expressed as

$${s}_{m} [ n ] = \frac{1}{\sqrt{{N}_{idft}}} {\sum }_{ℓ = 0}^{ℒ - 1} {d}_{ℓ , m} {e}^{j 2 πℓ \frac{n}{{N}_{idft}}} , - {N}_{cp} \leq n < {N}_{idft} , \qquad ( 12 )$$

where [symbol] is the symbol transmitted on the [symbol] th subcarrier of the mth OFDM symbol, N_{idft} is the inverse discrete Fourier transform (IDFT) size, and N_{cp} is the cyclic prefix (CP) size.

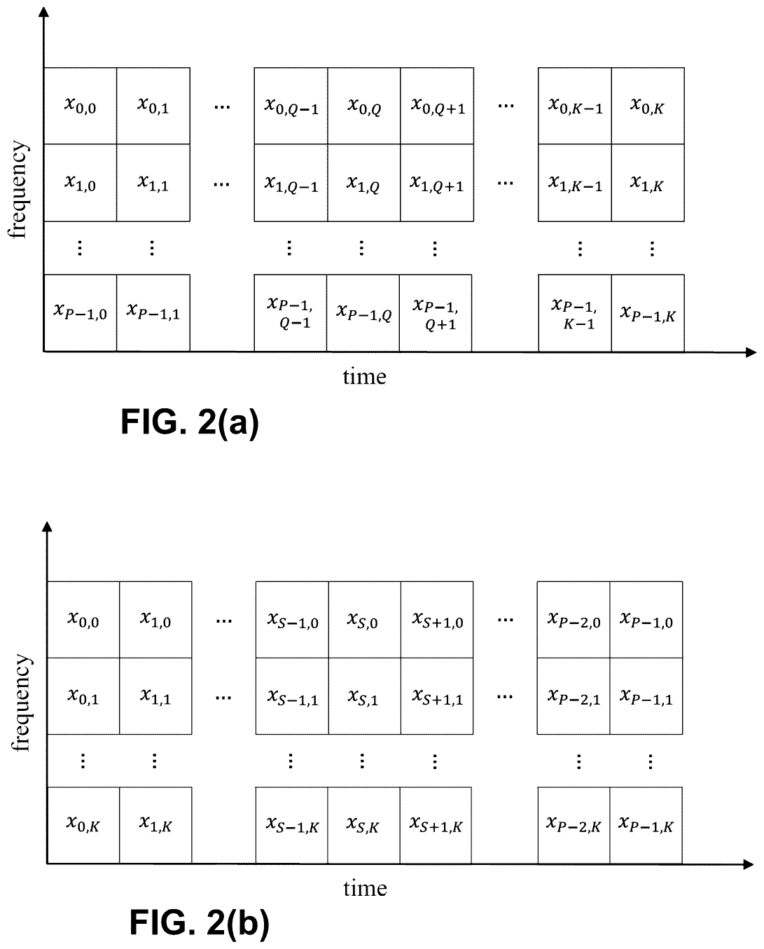

FIG. 2(a) graphically illustrates presently disclosed time-mapping principal sequence-to-subcarrier mappings for BMOCZ-based orthogonal frequency division multiplexing (OFD) in accordance with presently disclosed subject matter. As shown in FIG. 2(a), [symbol] is simply the pth polynomial coefficient of the mth polynomial sequence, i.e., [symbol] =x_{p,k} for [symbol] =p∈{0, 1, . . . , P−1} and m=k∈{0, 1, . . . , K}. Note that

$$Q = ⌈ \frac{K}{2} ⌉$$

in the figure. The advantage of time-mapping is that it can accommodate large K provided that the duration of each sequence is less than the coherence time of the channel. Moreover, even in a frequency-selective channel, each polynomial sequence experiences multiplication by a single complex gain due to the CP. Hence, no additional zeros are introduced to the transmitted sequences (i.e., L_{eff}=1).

Using frequency-mapping, the polynomial coefficients are mapped to subcarriers directly such that each OFDM symbol holds a single polynomial sequence, i.e., [symbol] =K+1 and d [symbol] m=xp,k for [symbol] =k and m=p. FIG. 2(b) graphically illustrates presently disclosed frequency-mapping principal sequence-to-subcarrier mappings for BMOCZ-based orthogonal frequency division multiplexing (OFDM), in accordance with presently disclosed subject matter. In particular, FIG. 2(b) illustrates the frequency-mapping approach where

$$S = ⌈ \frac{P - 1}{2} ⌉ .$$

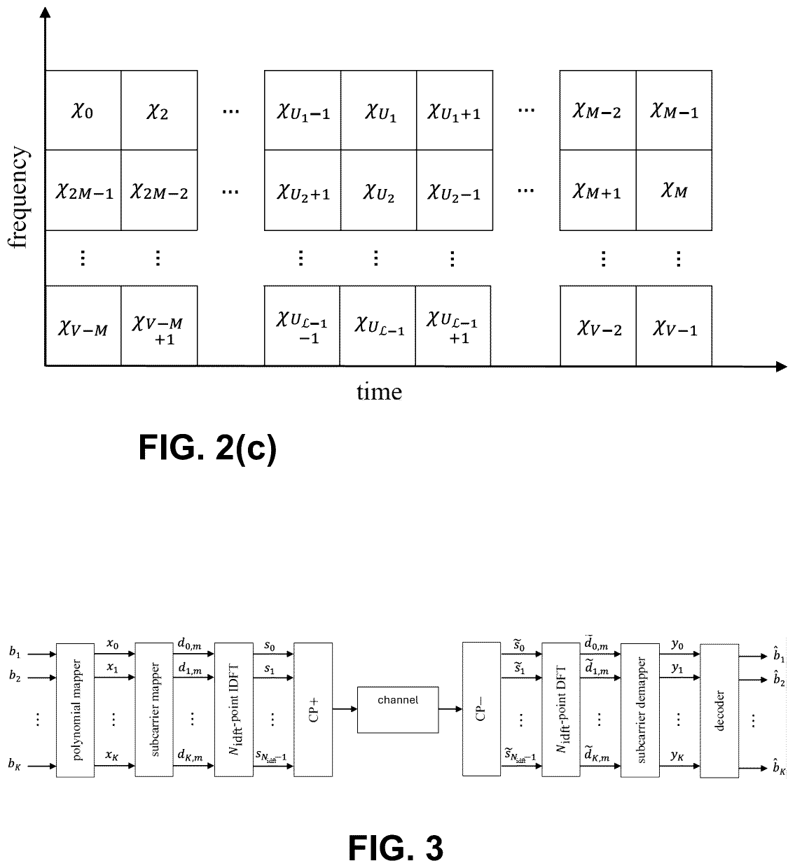

FIG. 3 depicts the block diagram of a general BMOCZ-based OFDM system implemented with frequency-mapping in accordance with presently disclosed subject matter. In particular, FIG. 3 graphically illustrates a block diagram representing exemplary processing of the mth OFDM symbol for a BMOCZ-based OFDM system implemented with presently disclosed frequency-mapping approach (m=p) in accordance with presently disclosed subject matter. Because Huffman sequences have almost ideal aperiodic auto-correlation functions [11], mapping the sequences to frequency and not time is beneficial for PAPR. However, the disadvantage of this approach is that coefficients of the same polynomial sequence can experience multiplication by different complex gains. The length of transmittable sequences is therefore limited by the coherence bandwidth of the channel, an imposition often much stricter than the coherence time in practice, particularly for low-mobility environments.

The time-frequency mapping approach is illustrated in FIG. 2(c), in particular graphically illustrating presently disclosed time-frequency mapping principal sequence-to-subcarrier mappings for BMOCZ-based orthogonal frequency division multiplexing (OFDM), in accordance with presently disclosed subject matter. Further, in FIG. 2(c) represented subject matter, V=P(K+1) and

$${U}_{ℓ} = ⌈ \frac{( 2 ℓ + 1 ) M + 1}{2} ⌉ .$$

The mapping utilizes M OFDM symbols and [symbol] =┌P(+1)/M┐ subcarriers. Let

$$χ = {( {x}_{𝔬}^{T} {x}_{1}^{T} … {x}_{P - 1}^{T} )}^{T} ∈ {P ( K + 1 ) \times 1}^{}$$

denote the complex-valued vector formed by aggregating all P polynomial sequence-vectors back-to-back. The mth OFDM symbol on the [symbol] th subcarrier is then given by [symbol] = [symbol] +m, where [symbol] ∈{0, 1, . . . , L−1} and m∈{0, 1, . . . ,M−1}. The advantage of time-frequency mapping is its flexibility, for either the number of OFDM symbols or subcarriers can be freely selected. This is not the case for time- and frequency-mapping approaches where, respectively, the number of OFDM symbols and subcarriers is fixed to K+1.

### IV. NUMERICAL RESULTS

### A. Decoder Performance at Optimal Radius

This section compares the performance of a BMOCZ-based OFDM scheme implemented using time-mapping and both the ML and DiZeT decoder. We simulate the transmission of OFDM symbols through both an AWGN and fading channel. In the AWGN channel, signals are perturbed by a noise vector w with elements drawn from a complex normal distribution having zero-mean and variance N₀, i.e., wᵢ˜CN(0, N₀). In the fading channel, the th OFDM symbol is multiplied by a singletap complex gain Hᵢ˜CN(0, 1) before being perturbed by AWGN. For each K, the radius used to generate codebooks is computed according to (9) and (11) for the DiZeT and ML decoder, respectively.

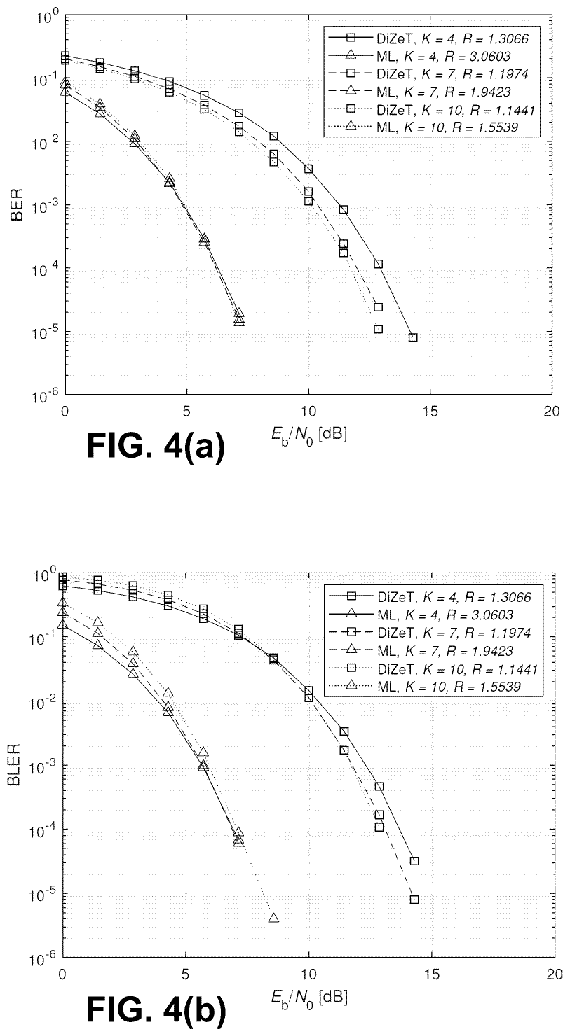

FIGS. 4(a) and 4(b) graphically illustrate comparison of the ML and DiZeT decoders in an AWGN channel. For each K, the radius Rwas chosen to maximize codeword and zero separation for the ML and DiZeT decoder, respectively. In particular, FIG. 4(a) graphically illustrates the bit error rate (BER) performance curves simulated in the AWGN channel for BMOCZ with K∈{4, 7, 10}, in accordance with presently disclosed subject matter. Likewise, FIG. 4(b) graphically illustrates the block error rate (BLER) performance curves simulated in the AWGN channel for BMOCZ with K∈{4, 7, 10}, in accordance with presently disclosed subject matter. Both the BER and BLER performance of the ML decoder outperform that of the DiZeT decoder by a margin greater than 5 dB. This result is expected as the polynomial coefficients of BMOCZ are more robust against additive noise than the zeros [9], [17].

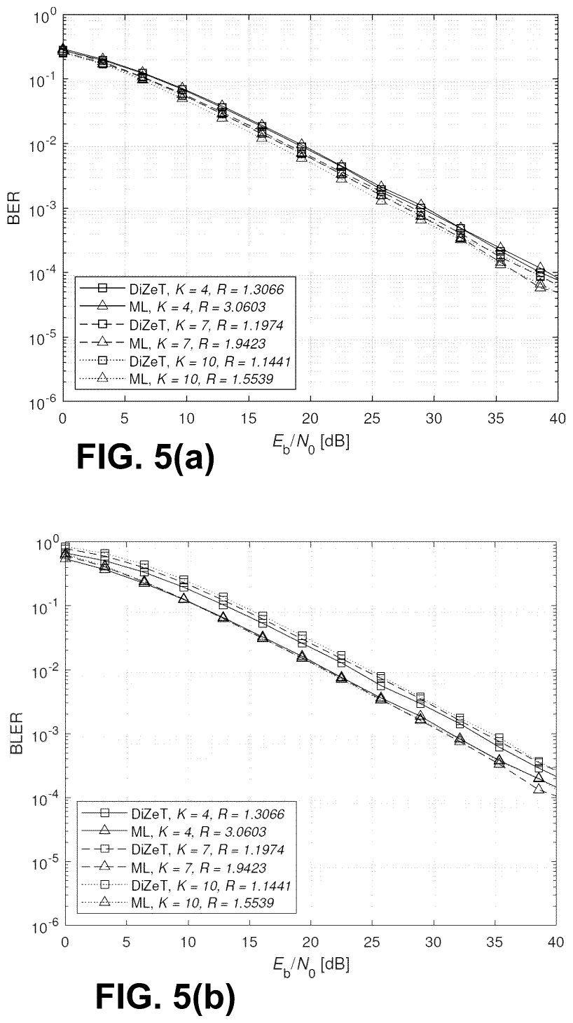

FIGS. 5(a) and 5(b) graphically illustrate comparison of the ML and DiZeT decoders in a fading channel with L=1. For each K, the radius R was chosen to maximize codeword and zero separation for the ML and DiZeT decoder, respectively. In particular, FIG. 5(a) graphically illustrates the bit error rate (BER) performance curves of the ML and DiZeT decoders in a fading channel with L=1 and for BMOCZ with K∈{4, 7, 10}. , in accordance with presently disclosed subject matter. Likewise, FIG. 5(b) graphically illustrates the block error rate (BLER) performance curves of the ML and DiZeT decoders in a fading channel with L=1 and for BMOCZ with K∈{4, 7, 10}, in accordance with presently disclosed subject matter. While the BER performance of the two decoders is comparable, notice that the ML decoder again outperforms the DiZeT decoder in BLER, this time by a margin of roughly 3 dB. Thus, for suitable choices of the radius R, the ML decoder achieves more reliable communication than the DiZeT decoder for BMOCZ.

### B. PAPR of OFDM Waveforms

In this section, we compare the peak-to-average power ratio (PAPR) of the described subcarrier mappings for BMOCZ-based OFDM. The PAPR of a discrete-time signal s[n] with length Nₛ is computed as

$${PAPR ( s [ n ] )}_{dB} = 10 {log}_{10} ( \frac{max {\vert s [ n ] \vert}^{2}}{{P}_{avg}} ) , \qquad ( 13 )$$

where P_{avg} is the average power of the signal, i.e.,

$${P}_{avg} = \frac{1}{{N}_{s}} {\sum }_{n = 0}^{{N}_{s} - 1} {\vert s [ n ] \vert}^{2} . \qquad ( 14 )$$

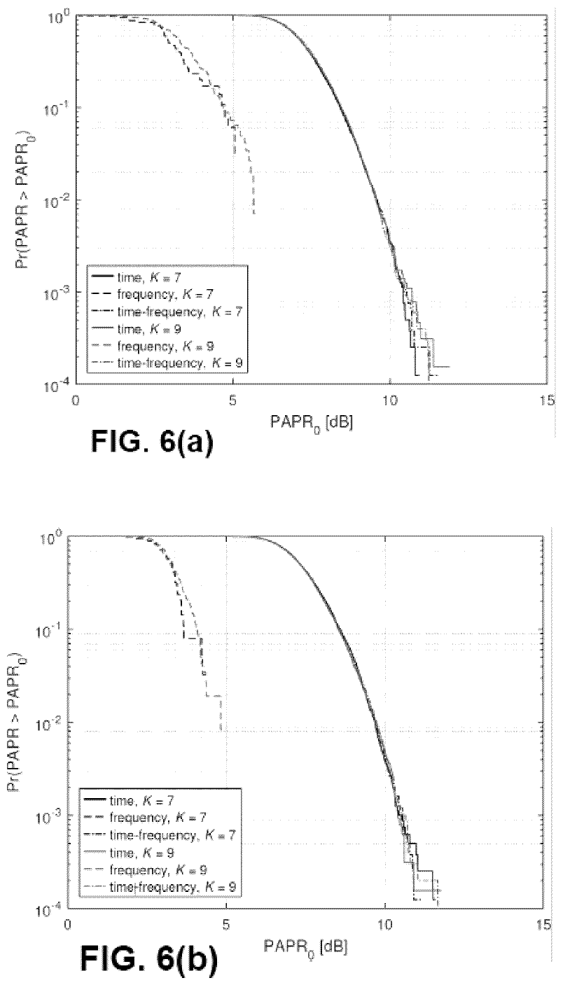

For our simulations, a single packet includes P=64 polynomial sequences. The IDFT size for each mapping strategy is N_{idft}=512, and a quadrature phase-shift keying (QPSK) scrambler is implemented for time-mapping and time-frequency mapping to reduce PAPR. FIG. 6(a) graphically illustrates the complementary cumulative distribution function (CCDF) of peak-to-average power ratio (PAPR) for BMOCZ-based OFDM waveforms employing different sequence-to-subcarrier mappings, including computed for K∈{7, 9} and the radius R from Equation (9) herein, in accordance with presently disclosed subject matter. FIG. 6(b) graphically illustrates another example of the complementary cumulative distribution function (CCDF) of peak-to-average power ratio (PAPR) for BMOCZ-based OFDM waveforms employing different sequence-to-subcarrier mappings, including computed for K∈{7, 9} and the radius Rfrom Equation (11) herein, in accordance with presently disclosed subject matter. While there appears no appreciable difference between PAPR for time-mapping and time-frequency mapping, PAPR is indeed minimized by mapping the polynomial sequences directly in frequency.

### C. Performance of OFDM Waveforms

This section compares the performance of the OFDM subcarrier mappings in a fading channel. We consider a decaying exponential PDP having L taps given by

$${ρ}_{l} = [ {\vert {h}_{l} \vert}^{2} ] = \frac{1 - ρ}{1 - {ρ}^{L}} {ρ}^{l} , \qquad ( 15 )$$

where I∈{0, 1, . . . ,L−1} and ρ∈(0, 1) is the profile's decay constant [9]. Simulations are performed with packets comprising P=64 polynomial sequences, L=K=9, and ρ=0.2. The number of OFDM symbols and subcarriers considered for time-frequency mapping is M=5 and [symbol] =128, respectively. For the DiZeT and ML decoder, we again generate BMOCZ codebooks using the corresponding radii in (9) and (11).

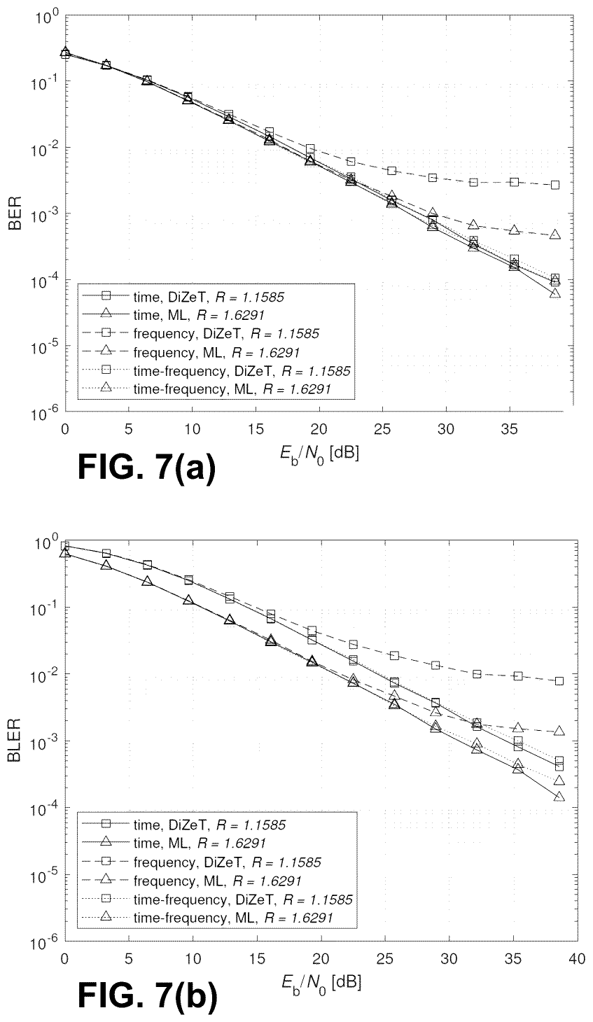

FIG. 7(a) graphically illustrates the bit error rate (BER) performance curves of the OFDM subcarrier mappings in a fading channel for L=K=9 and ρ=0.2, in accordance with presently disclosed subject matter. FIG. 7(b) graphically illustrates the block error rate (BLER) performance curves of the OFDM subcarrier mappings in a fading channel for L=K=9 and ρ=0.2, in accordance with presently disclosed subject matter. The radius Rwas chosen to maximize codeword and zero separation for the ML and DiZeT decoder, respectively.

Stated another way, FIGS. 7(a) and 7(b) respectively illustrate the BER and BLER curves of the three sequence-to-subcarrier mappings simulated in a fading channel for BMOCZ-based OFDM implemented with both a ML and DiZeT decoder. As anticipated from the discussion in Section III-A, the time-mapping waveform outperforms the frequency mapping waveform as each polynomial sequence experiences flat-fading. It can be seen that the time-frequency mapping strategy performs similarly to the time-mapping approach. Given its heightened flexibility, however, we regard the time-frequency waveform as the most practical for real implementations, provided that PAPR is not a primary design constraint.

### V. CONCLUDING REMARKS

In this disclosure, we refer to the radius for BMOCZ that maximizes the reliability of communication. We first show that different radii maximize zero and codeword separation and that the optimal radius for BMOCZ is a function of the utilized decoder (i.e., ML or DiZeT). Simulations of a BMOCZ-based OFDM waveform in both an AWGN and fading channel validate that the ML decoder outperforms the DiZeT decoder for suitable choices of the radius parameter. Finally, we discuss the merits of different sequence-to-subcarrier mappings for BMOCZ-based OFDM to limit the number of zeros introduced by the channel. We presently disclose a flexible time-frequency mapping waveform that is robust against a frequency-selective channel at the expense of increased PAPR. Future efforts may focus on the following: (1) the optimal radius for MOCZ more generally; (2) the derivation of an expression for the radius maximizing codeword separation; and (3) further quantitative analysis of the introduced BMOCZ-based OFDM waveforms.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

### REFERENCES

[1]C. Bockelmann, N. Pratas, H. Nikopour, K. Au, T. Svensson, C. Stefanovic, P. Popovski, and A. Dekorsy, “Massive machine-type communications in 5G: Physical and MAC-layer solutions,” IEEE Communications Magazine, vol. 54, no. 9, pp. 59-65, 2016.
[2]P. Popovski, “Ultra-reliable communication in 5G wireless systems,” in Proc. 1st International Conference on 5G for Ubiquitous Connectivity. IEEE, 2014, pp. 146-151.
[3]G. Wunder, H. Boche, T. Strohmer, and P. Jung, “Sparse signal processing concepts for efficient 5G system design,” IEEE Access, vol. 3, pp. 195-208, 2015.
[4]X. You, C.-X. Wang, J. Huang, X. Gao, Z. Zhang, M. Wang, Y. Huang, C. Zhang, Y. Jiang, J. Wang et al., “Towards 6G wireless communication networks: Vision, enabling technologies, and new paradigm shifts,” Science China Information Sciences, vol. 64, pp. 1-74, 2021.
[5]S. J. Nawaz, S. K. Sharma, B. Mansoor, M. N. Patwary, and N. M. Khan, “Non-coherent and backscatter communications: Enabling ultramassive connectivity in 6G wireless networks,” IEEE Access, vol. 9, pp. 38 144-38 186, 2021.
[6]K. Witrisal, G. Leus, G. J. Janssen, M. Pausini, F. Trosch, T. Zasowski, and J. Romme, “Noncoherent ultra-wideband systems,” IEEE Signal Processing Magazine, vol. 26, no. 4, pp. 48-66, 2009.
[7]C. Xu, N. Ishikawa, R. Rajashekar, S. Sugiura, R. G. Maunder, Z. Wang, L.-L. Yang, and L. Hanzo, “Sixty years of coherent versus non-coherent tradeoffs and the road from 5G to wireless futures,” IEEE Access, vol. 7, pp. 178 246-178 299, 2019.
[8]P. Walk, P. Jung, and B. Hassibi, “Short-message communication and FIR system identification using Huffman sequences,” in Proc. IEEE International Symposium on Information Theory (ISIT). IEEE, 2017, pp. 968-972.
[9], -----, MOCZ for blind short-packet communication: Basic principles,” IEEE Transactions on Wireless Communications, vol. 18, no. 11, pp. 5080-5097, 2019.
[10]P. Walk, P. Jung, B. Hassibi, and H. Jafarkhani, “MOCZ for blind short-packet communication: Practical aspects,” IEEE Transactions on Wireless Communications, vol. 19, no. 10, pp. 6675-6692, 2020.
[11]M. H. Ackroyd, “The design of Huffman sequences,” IEEE Transactions on Aerospace and Electronic Systems, no. 6, pp. 790-796, 1970.
[12]A. A. Siddiqui, E. Bedeer, H. H. Nguyen, and R. Barton, “Spectrally efficient modulation on conjugate-reciprocal zeros (SE-MOCZ) for noncoherent short packet communications,” IEEE Transactions on Wireless Communications, 2023.
[13]B. Sasidharan, E. Viterbo, and Y. Hong, “Alternative zero codebooks for MOCZ with reduced PAPR,” IEEE Communications Letters, 2024.
[14]Y. Sun, Y. Zhang, G. Dou, Y. Lu, and Y. Song, “Noncoherent SIMO transmission via MOCZ for short packet-based machine-type communications in frequency-selective fading environments,” IEEE Open Journal of the Communications Society, 2023.
[15]P. Walk and W. Xiao, “Multi-user MOCZ for mobile machine type communications,” in Proc. IEEE Wireless Communications and Networking Conference (WCNC). IEEE, 2021, pp. 1-6.
[16]G. Forney, “Maximum-likelihood sequence estimation of digital sequences in the presence of intersymbol interference,” IEEE Transactions on Information Theory, vol. 18, no. 3, pp. 363-378, 1972.
[17]J. H. Wilkinson, “The perfidious polynomial,” Studies in Numerical Analysis, vol. 24, pp. 1-28, 1984.

What is claimed is:

1. A binary data transmission method, comprising:
a discrete-time baseband signal; and
using a non-coherent communication scheme for transmitting the baseband signal, comprising a binary modulation on conjugate-reciprocal zeros (BMOCZ) modulation scheme, using a polynomial scheme for encoding and decoding;
wherein BMOCZ has a radius parameter R determining the spacing between conjugate-reciprocal zero pairs, the radius parameter R is selected to be greater than 1, and R is selected to maximize zero or polynomial separation, depending on the implemented decoder at the receiver.

2. The method according to claim 1, wherein:
the BMOCZ modulation scheme comprises converting the baseband signal into the z-domain in the form of a polynomial; and
transmitting the baseband signal comprises transmitting a sequence constituting the coefficients of the polynomial of the converted z-domain baseband signal.

3. The method according to claim 2, wherein the BMOCZ modulation scheme encodes information bits into the zeros of the baseband signal's z-transform.

4. The method according to claim 3, further comprising conducting decoding of a received polynomial sequence using one of a maximum likelihood (ML) and direct zero-testing (DiZeT) decoder.

5. The method according to claim 4, wherein the decoder comprises a maximum likelihood (ML) decoder.

6. The method according to claim 1, further comprising:
using a decoder comprising a maximum likelihood (ML) decoder; and
integrating the BMOCZ modulation scheme with an orthogonal frequency division multiplexing (OFDM) multi-carrier modulation scheme.

7. The method according to claim 6, further comprising using at least one of three separate sequence-to-subcarrier mappings for the integrated BMOCZ-based orthogonal frequency division multiplexing (OFDM) modulation scheme, comprising time-mapping, frequency-mapping, and time-frequency mapping.

8. The method according to claim 7, further comprising using time-mapping sequence-to-subcarrier mappings for the integrated BMOCZ-based orthogonal frequency division multiplexing (OFDM) modulation scheme, for efficiently accommodating relatively large polynomial sequences.

9. The method according to claim 6, further comprising using the non-coherent communication scheme for implementation in at least one of the Internet-of-Things, machine-type communications, sensor networks, radar systems, autonomous vehicle systems, and robotic systems.

10. The method according to claim 2, wherein the BMOCZ modulation scheme comprises encoding information bits onto the zeros of the polynomial of the converted z-domain baseband signal and letting the coefficients of the polynomial modulate a carrier, to allow digital information to be impressed on electromagnetic radiation from the BMOCZ modulation scheme.

11. A binary data transmission system, comprising:
an input source for providing information bits;
one or more processors; and
one or more non-transitory computer-readable media that store instructions that, when executed by the one or more processors, cause the one or more processors to perform operations, the operations comprising:
generating a baseband signal; and
using a non-coherent communication scheme for transmitting the baseband signal, comprising a binary modulation on conjugate-reciprocal zeros (BMOCZ) modulation scheme, using a polynomial scheme for encoding and decoding;
wherein BMOCZ has a radius parameter R determining the spacing between conjugate-reciprocal zero pairs, the radius parameter R is selected to be greater than 1, and R is selected to maximize zero or polynomial separation, depending on the decoder implemented at the receiver.

12. The binary data transmission system according to claim 11, wherein the one or more processors are further programmed to perform operations so that the BMOCZ modulation scheme comprises converting the baseband signal into the z-domain in the form of a polynomial, and transmitting the baseband signal comprises transmitting a sequence comprising the coefficients of the polynomial of the converted z-domain baseband signal.

13. The binary data transmission system according to claim 12, wherein the one or more processors are further programmed to perform operations so that the BMOCZ modulation scheme encodes information bits into the zeros of the baseband signal's z-transform.

14. The binary data transmission system according to claim 13, wherein the one or more processors are further programmed so that operations further comprise conducting decoding of a received polynomial sequence using one of a maximum likelihood (ML) and direct zero-testing (DiZeT) decoder.

15. The binary data transmission system according to claim 14, wherein the decoder comprises a maximum likelihood (ML) decoder.

16. The binary data transmission system according to claim 11, wherein the one or more processors are further programmed so that operations further comprise:
using a decoder comprising a maximum likelihood (ML) decoder; and
integrating the BMOCZ modulation scheme with an orthogonal frequency division multiplexing (OFDM) multi-carrier modulation scheme.

17. The binary data transmission system according to claim 16, wherein the one or more processors are further programmed so that operations further comprise using at least one of three separate sequence-to-subcarrier mappings for the integrated BMOCZ-based orthogonal frequency division multiplexing (OFDM) modulation scheme, comprising time-mapping, frequency-mapping, and time-frequency mapping.

18. The binary data transmission system according to claim 17, wherein the one or more processors are further programmed so that operations further comprise using time-mapping sequence-to-subcarrier mappings for the integrated BMOCZ-based orthogonal frequency division multiplexing (OFDM) modulation scheme, for efficiently accommodating relatively large polynomial sequences.

19. The binary data transmission system according to claim 16, wherein the input source is associated with at least one of the Internet-of-Things, machine-type communications, sensor networks, radar systems, autonomous vehicle systems, robotic systems, and smart devices.

20. The binary data transmission system according to claim 1, wherein the one or more processors are further programmed so that the BMOCZ modulation scheme further comprises encoding information bits onto the zeros of the polynomial of the converted z-domain baseband signal and letting the coefficients of the polynomial modulate a carrier, to allow digital information to be impressed on electromagnetic radiation from the BMOCZ modulation scheme.
